(19) United States
(12) Patent Application Publication
(10) Pub. No.: US 2007/0006234 A1
(43) Pub. Date: Jan. 4, 2007

(54) Batch processing support apparatus and method, and storage medium storing program therefor

(75) Inventor: Naoya Ogata, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/255,923

(22) Filed: Oct. 24, 2005

(30) Foreign Application Priority Data
Jul. 1, 2005 (JP) 2005-193757

(51) Int. Cl. G06F 9/46

(52) U.S. Cl. 718/101

(57) ABSTRACT

A batch processing support apparatus for supporting batch processing in which a batch of individual processing tasks are sequentially executed, comprises a list display that displays a list of a plurality of individual processing tasks and batch processing tasks in which the plurality individual processing tasks are sequentially combined; a selection unit that selects and displays a plurality of desired processing tasks from the individual processing tasks and batch processing tasks displayed by the list display; a rearrangement unit that rearranges the plurality of processing tasks selected by the selection unit; a registering unit that registers a new batch processing task which sequentially executes the processing tasks in an order rearranged by the rearrangement unit; and a batch processing executing unit that executes the batch processing task registered by the registering unit.

### BACKGROUND OF THE INVENTION

1. Field of the Invention

The present invention relates to batch processing support apparatus and method, and storage medium storing a program therefor, and particularly to batch processing support apparatus and method, and storage medium storing a program therefor in which, in addition to modularized individual processing tasks for performing predetermined processing of various types, batch processing tasks for sequentially executing plural individual processing tasks are registered as processing tasks to be executed by batch processing, and a user easily confirms setting contents of the plural processing tasks registered for the batch processing.

2. Description of the Related Art

When a personal computer (PC) is used to issue a print instruction to a printing system such as a printer or a copier, or to perform electronic mail (e-mail) communication with various communication apparatuses connected via a network, the personal computer is installed with application software for various processing programs such as a print processing program for performing print processing, an e-mail communication processing program for performing e-mail communication processing, a facsimile communication processing program for performing facsimile communication processing, a file transfer processing program for performing file transfer processing, a network monitoring processing program for performing network monitoring processing (hereafter, these applications are to be referred to as “client applications”). These client applications can be executed as required to enable the printing system to perform print processing and enable the network system to perform e-mail communication.

Some of the client applications have a batch processing function in which plural processing tasks including print processing and e-mail communication processing are registered as single batch processing task (job flow), so that these processing tasks registered for the batch processing are automatically and sequentially executed by the execution of the batch processing according to a sequence.

Japanese Patent Application Publication Nos. 07-056725 and 11-039145, for example, propose a program creation support apparatus and method, according to which each of various processing including print processing is modularized, each modularized processing task is represented by an icon, and icons representing desired processing tasks are arranged and connected with arrows so that the desired processing tasks are executed according to the sequence indicated by the arrows.

The above-mentioned Japanese Patent Application Publication Nos. 07-056725 and 11-039145 also propose, as methods for registering processing tasks to be executed in batch processing, a first method of registering processing tasks to be executed in batch processing every time a batch processing task is created, and a second method of previously registering processing tasks in a template, and, when creating a batch processing task, selecting processing tasks to be executed in the batch processing task from the template and registering the selected processing tasks for the batch processing.

Specifically, according to the first method, when e-mail communication processing is to be executed in batch processing, for example, an address, a message title, a file format and the like required for the e-mail communication processing task are set every time a new batch processing task is created.

According to the second method, settings of an address, a message title, a file format an the like are previously registered in a template, so that the settings of the address, message subject, file format and the like registered in the template are reused when a batch processing task including e-mail communication processing is newly created.

The above-mentioned Japanese Patent Application Publication Nos. 07-056725 and 11-039145 also propose a method of displaying setting contents of batch processing, which is designed such that setting contents of a processing task registered in the batch processing is displayed in a sub-window by selecting an icon associated with the processing task.

According to the proposal by the Japanese Patent Application Publication Nos. 07-056725 and 11-039145, however, every time a new batch processing file is created, it is necessary to add settings of processing required for the batch processing.

When a new batch processing task is created using a template in which various processing tasks are preset, and if a processing task required for the batch processing task is not set in the template, it is required to create a new template by extracting the settings of the required processing task from any other template having the settings thereof, or to additionally set the required processing in the template being used. This poses a problem of making it difficult to reuse the existing settings of processing tasks.

In addition, to display setting contents of batch processing, an icon is selected from various icons representing processing tasks registered for the batch processing, so that the setting contents of the processing task associated with the selected icon are displayed in a sub-window. This makes it difficult to view at a time the whole setting contents of the plural processing tasks registered for the batch processing.

### SUMMARY OF THE INVENTION

The present invention has been made in view of the above circumstances and provides a batch processing support apparatus and method, and storage medium storing a program therefor in which, in addition to modularized individual processing tasks for performing predetermined processing of various types, batch processing tasks for sequentially executing plural individual processing tasks are registered as processing tasks to be executed by batch processing, and a user easily confirms setting contents of the plural processing tasks registered for the batch processing.

According to an aspect of the present invention, a batch processing support apparatus for supporting batch processing in which a batch of individual processing tasks are sequentially executed, comprises a list display that displays a list of a plurality of individual processing tasks and batch processing tasks in which the plurality individual processing tasks are sequentially combined; a selection unit that selects and displays a plurality of desired processing tasks from the individual processing tasks and batch processing tasks displayed by the list display; a rearrangement unit that rearranges the plurality of processing tasks selected by the selection unit; a registering unit that registers a new batch processing task which sequentially executes the processing tasks in an order rearranged by the rearrangement unit; and a batch processing executing unit that executes the batch processing task registered by the registering unit.

### BRIEF DESICRIPTION OF THE DRAWINGS

Embodiments of the present invention will be described in detail based on the following figures, wherein:

FIG. 1 is a diagram illustrating an example of an overall configuration of a network system to which a batch processing support apparatus and method, and storage medium storing a program therefor according to the present invention is applied;

FIG. 2 is a block diagram illustrating a functional configuration of a batch processing support program 100 according to the present invention;

FIG. 3 is a flowchart illustrating operation of the batch processing support program 100;

FIG. 4 is a diagram illustrating an example of a batch processing support screen 400;

FIG. 5 is a diagram illustrating an example of a tilt correction property screen 500; and

FIG. 6 is diagram illustrating an example of a batch processing settings registering screen 600.

### DETAILED DESCRIPTION OF THE INVENTION

A detailed description will now be made of a batch processing support apparatus and method, and medium for storing a program therefor according to embodiment of the present invention, with reference to the accompanying drawings.

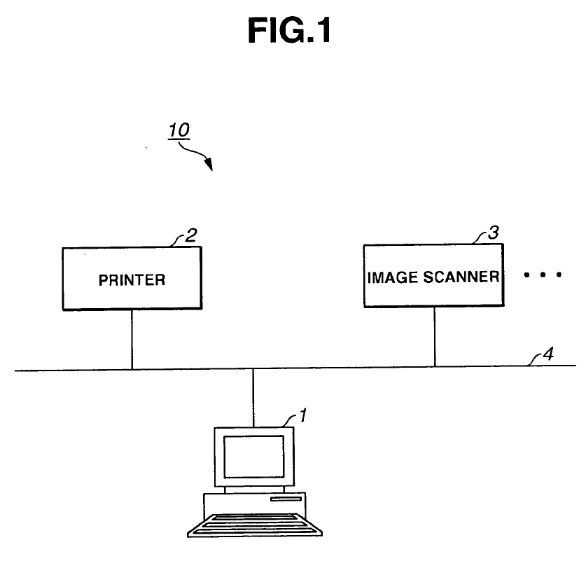

FIG. 1 is a diagram schematically illustrating an overall configuration of a network system to which a batch processing support apparatus and method, and program according to the present invention is applied.

As shown in FIG. 1, the network system 10 has a batch processing support apparatus 1 which is connected to a printer 2, an image scanner 3 and other apparatuses via a network 4 such as LAN (Local Area Network).

The batch processing support apparatus 1 is formed by a computer, so-called client PC (Personal Computer), which comprises a CPU (Central Control Unit), an input/output device, a storage device and so on. The batch processing support apparatus 1 is installed with an OS (Operating System) for system control of the batch processing support apparatus 1, a batch processing support program 100 (to be described in detail later) for controlling the operation of the batch processing support method according to the present invention, protocols such as TCP/IP (Transmission Control Protocol/Internet Protocol), FTP (File Transfer Protocol), and SNMP (Simple Network Management Protocol), and software such as application programs for performing various processing tasks.

By installing the client PC with the batch processing support program 100 and activating the batch processing support program 100, the batch processing support apparatus 1 according to the present invention is enabled to set various individual processing tasks to be performed by the printer 2, image scanner 3 and other apparatuses connected to the network 4 (e.g., print processing, and image scan processing) and to set batch processing for sequentially executing plural individual processing tasks according to a predetermined procedures. The batch processing support apparatus 1 is also able to set a batch processing task already set as a processing task to be executed by newly created batch processing. Therefore, the batch processing support apparatus 1 is able to easily create batch processing for sequentially executing plural individual processing tasks or batch processing tasks according to a series of procedures.

In addition to the printer 2 and the image scanner 3, the network 4 may be connected to a copier, various types of servers, and other apparatuses (not shown). The batch processing support apparatus 1 is able to easily set various individual processing tasks performed by these apparatuses (e.g., e-mail communication processing, facsimile communication processing, file transfer processing, and network monitoring processing), as well as a batch processing task in which these individual processing tasks are combined. Further, the batch processing support apparatus 1 according to the present invention is also able to easily create a new batch processing task in which individual processing tasks are combined with batch processing tasks.

The above-mentioned individual processing tasks may be processing tasks which are executable by the batch processing support apparatus 1 itself which is installed alone.

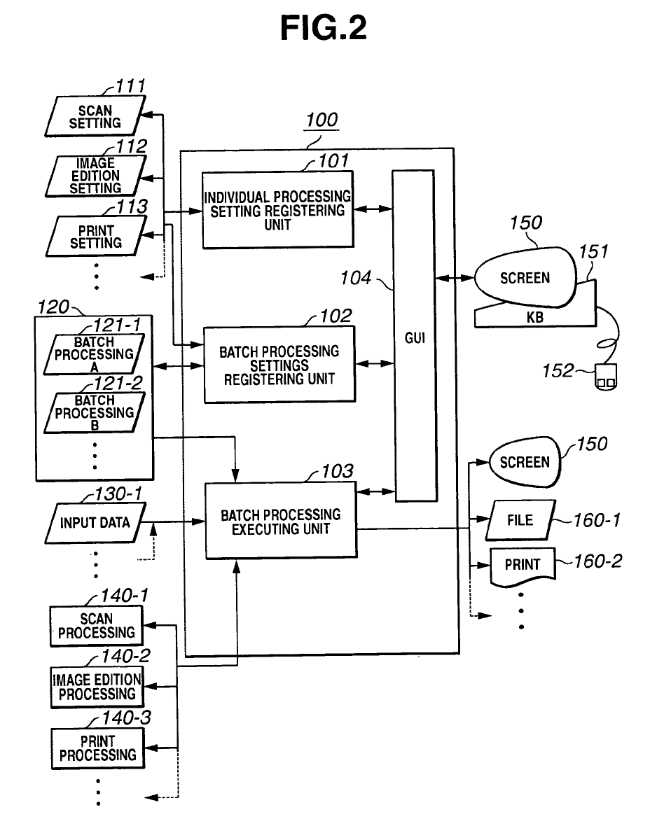

FIG. 2 is a block diagram illustrating a functional configuration of the batch processing support program 100 according to the present invention.

As shown in FIG. 2, the batch processing support program 100 comprises a individual processing settings registering unit 101, a batch processing settings registering unit 102, a batch processing execution unit 103, and a GUI (Graphical User Interface) 104 for controlling user interfaces such as a screen device 150, a keyboard (KB) 151 and a mouse 152, which are used to enter or display information when the user gives instructions and operates the program.

The individual processing settings registering unit 101 stores, in predetermined folders, various settings required for executing various individual processing tasks with the apparatuses connected to the network 4, for example, a print processing task 140-3 performed with the printer 2, a scan processing task 140-1 performed with the image scanner 3, and an e-mail communication processing task (not shown) performed among the apparatuses mutually connected via the network 4. For example, the individual processing settings registering unit 101 stores settings information such as addresses, message titles, and file formats used in an e-mail transmission processing task, in a predetermined folder (e.g., an-e mail settings folder not shown in the drawing). The individual processing settings registering unit 101 also manages the settings information for individual processing tasks already stored in the predetermined folders (e.g., a scan settings folder 111, an image edition settings folder 112, and a print settings folder 113), while amending and deleting the contents of the settings information.

The batch processing settings registering unit 102 stores various settings information required for executing batch processing, that is, various settings required for sequentially executing plural individual processing tasks registered for the batch processing according to a series of procedures, in predetermined folders including a batch processing A folder 121-1, a batch processing B folder 121-2 and other folders (hereafter, to be generally referred to as the “batch processing settings information folder 121-n”)). For example, the batch processing settings registering unit 102 stores the sequence of executing the individual processing tasks as determined based on the natures of the individual processing tasks registered for the batch processing or the executing sequence designated by the user, and information on the individual processing tasks registered for the batch processing. The batch processing settings registering unit 102 also manages the various settings stored in the predetermined folders (batch processing settings information folders 121-n), while amending and deleting the contents of the settings information.

The batch processing execution unit 103 analyzes the batch processing settings information stored in a batch processing settings information folder 121-n that is selected for executing the batch processing, and accesses and executes the individual processing tasks registered for the batch processing in a sequential order based on the analysis result.

More specifically, the batch processing execution unit 103 sequentially accesses the individual processing tasks or the individual processing tasks in the batch processing already registered according to the settings information of the individual processing tasks registered for the batch processing or of the batch processing, for example, according to the sequence of executing the individual processing tasks such as the scan processing task 140-1 for scanning images by means of the image scanner 3, the image edition processing task 140-2 for performing image edition such as noise removal on the image data, and the print processing task 140-3 for printing out the image data by means of the printer 2 (hereafter, to be generally referred to as the “individual processing task 140-n”) or according to the order of executing the processing tasks (individual processing tasks and batch processing tasks) in the batch processing already registered. The batch processing execution unit 103 then executes the individual processing tasks according to the settings of the individual processing tasks. After input data 130-1, . . . required by the executed individual processing tasks (hereafter, to be generally referred to as the “input data 130-n”) are input for the respective individual processing tasks and processed as required, the processed data are output to the screen device 150, a file 160-1, print paper 160-2, or other medium or apparatus according to the nature of each individual processing task.

The GUI 104 performs user interface control to display a screen for entering or displaying information when the user gives instructions to or operates the batch processing support program 100 during operation of the units 101, 102 and 103, and to transfer the information set on the screen to the units 101, 102 and 103.

The screen data displayed on the screen device 150 during operation of the units 101, 102 and 103 are previously generated and stored in a storage device. The GUI 104 reads the screen data required for the operation of the units 101, 102 and 103 from the storage device as needed, and displays the same on the screen device 150.

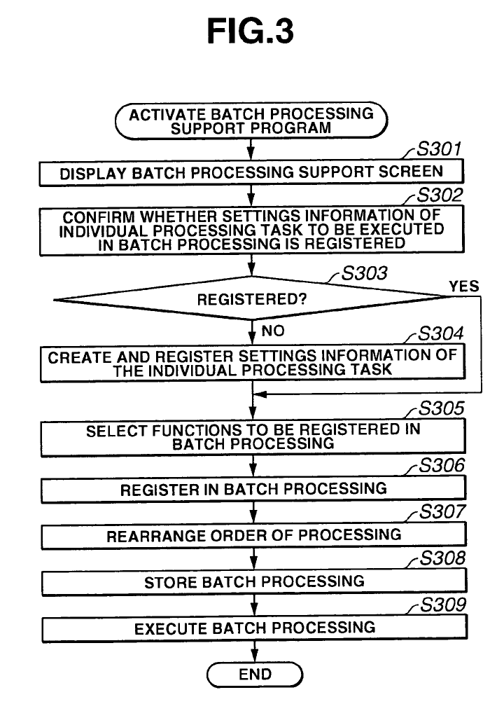

A description will now be made of operation of the batch processing support program 100 structured as described above, with reference to the flowchart of FIG. 3.

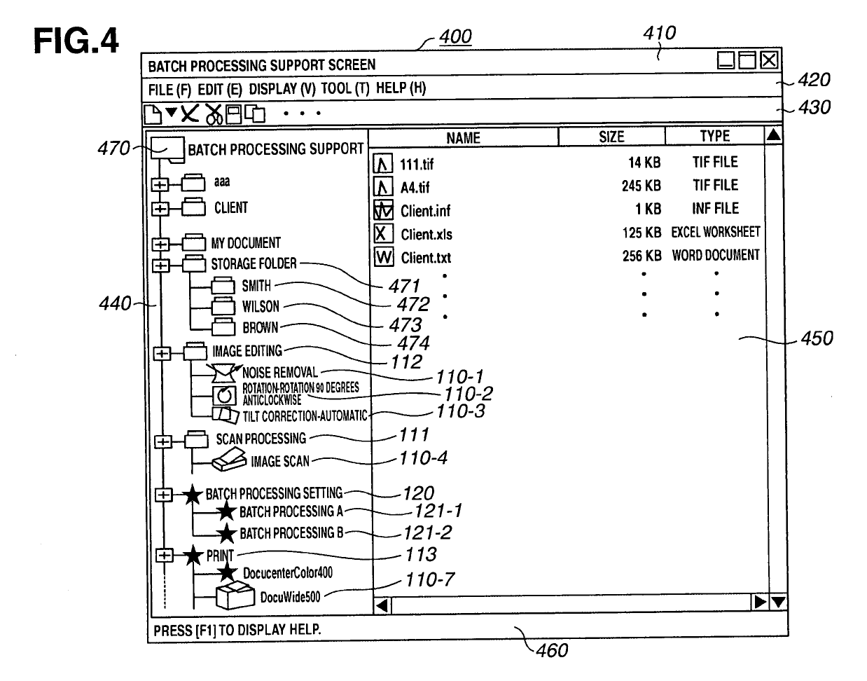

As shown in FIG. 3, when activated, the batch processing support program 100 displays a batch processing support screen 400 (see FIG. 4, to be described in detail later) on the screen device 150 by means of the GUI 104 (step S301).

The user views a list of folders and files stored in a batch processing support folder 470 that is displayed on the batch processing support screen 400 and confirms whether settings information of the individual processing task to be executed as part of the batch processing is registered or not (step S302). If the settings information of the individual processing task is not registered (NO in step S303), the user selects “Register Settings of Individual processing” from a pop-up menu (not shown) displayed on the batch processing support screen 400 so that the batch processing support program 100 registers the settings information of the individual processing task by means of the GUI 104 and the individual processing settings registering unit 101 (step S304).

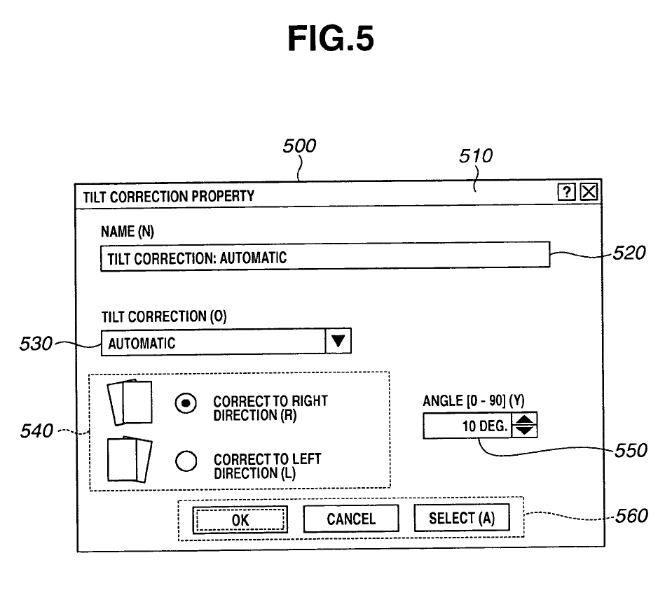

More specifically, when the right mouse button is clicked on the batch processing support folder 470 or on a folder in the batch processing support folder 470 in which the settings information of a individual processing is to be registered, a pop-up menu (not shown) is displayed. When “Register Settings of Individual processing” is selected from the pop-up menu, another pop-up menu (not shown) is displayed to show a list of individual processing tasks. The user selects a desired individual processing task from the list in the pop-up menu, whereby a settings registering screen 500 (see FIG. 5, to be described in detail later) for the selected individual processing task is displayed on the batch processing support screen 400. The user is thus allowed to enter desired data in a predetermined settings entry box in the displayed settings registering screen 500 for the individual processing task (hereafter, to be referred to as the “individual processing settings registering screen 500”), and to select a selection item, so that the contents of settings for the individual processing task are registered as settings information in the selected folder or the batch processing support folder 470.

The confirmation whether the settings information for the individual processing task to be executed as part of the batch processing is registered or not can be performed by checking whether or not an icon for a folder assigned with a name related to the setting contents for the individual processing task is displayed in the list of folders and files in the batch processing support folder 470, and causing the contents of the settings information stored in the folder of the icon to be displayed.

The batch processing support folder 470 stores processing programs for individual processing tasks, files of various data, and folders storing these files, required for operation of the batch processing support program 100.

When it is determined, in step 303, that the settings information of the individual processing task to be executed in the batch processing is registered in the batch processing support folder 470 (YES in step S303), or after the settings information of the individual processing task to be executed in the batch processing is registered in the batch processing support folder 470 by creating the same (step S304), a pop-up menu is displayed on the batch processing support screen 400 to allow the user to select “Register Settings of Batch Processing” (step S305). Thereby, new settings information of batch processing is generated and stored so that the batch processing support program 100 causes the GUI 104 and the batch processing settings registering unit 102 to sequentially execute the individual processing tasks or the individual processing tasks in the already registered batch processing according a series of procedures.

More specifically, a pop-up menu is displayed by clicking on the batch processing support folder 470 or on the batch processing settings folder 120 in the batch processing support folder 470 with the right mouse button. By selecting “Register Settings of Batch Processing” from this pup-up menu, various processing including setting of the batch processing and amendment or deletion of the setting contents thereof are performed by means of the GUI 104 and the batch processing settings registering unit 102.

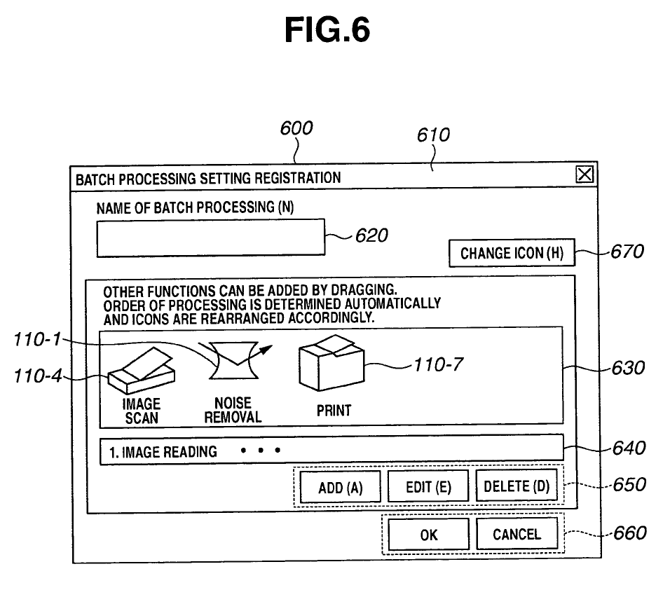

When the user selects “Register Settings of Batch Processing”, the batch processing support program 100 displays a batch processing settings registering screen 600 (see FIG. 6, to be described in detail later) on the batch processing support screen 400. The user is thus allowed to select icons for the folders in which settings information of the individual processing tasks to be executed in batch processing or of the batch processing tasks is stored from the list of folders in the batch processing support folder 470 displayed on the batch processing support screen 400 and to drag and drop the selected icons on a batch processing registering portion 630 in the batch processing settings registering screen 600. Thereby, the icons for the folders in which the settings information for the individual processing tasks or the batch processing, or the icons for the individual processing tasks forming the batch processing are copied in the batch processing registering portion 630. The settings information of the individual processing tasks or the batch processing associated with the copied icons is registered as new batch processing (step S306).

When the icons for the folders in which the settings information of the individual processing tasks or the batch processing tasks is stored are copied and displayed in the batch processing registering portion 630 in the batch processing settings registering screen 600, the sequence of executing the individual processing tasks or the batch processing tasks is determined automatically based on the settings information and processing natures thereof stored in the folders indicated by the icons, provided that those processing tasks are to be executed in a limited sequence of order. The icons for the folders having the settings information of the individual processing tasks or the batch processing tasks stored therein are then rearranged and displayed in the batch processing registering portion 630 in the order thus determined (step S307).

So far as not prohibited by the restriction to the order of executing the processing tasks, the user is able to change the arrangement of the icons for the folders having the settings information of the individual processing tasks or the batch processing tasks stored therein, which are displayed in the batch processing registering portion 630 of the batch processing settings registering screen 600, by dragging and dropping the icons displayed in the batch processing registering portion 630.

After confirming that the icons for the folders having the settings information of the individual processing tasks to be executed in batch processing or of the batch processing tasks stored therein have been copied in the batch processing registering portion 630 of the batch processing settings registering screen 600, the user enters the name of the batch processing in a batch processing name entry box 620 in the batch processing settings registering screen 600 and then clicks with the mouse on an “OK” button which is one of the operating buttons of the batch processing settings registering screen 600. Thereupon, the batch processing support program 100 generates settings information for new batch processing for executing the individual processing tasks or the batch processing tasks of the settings information associated with the icons displayed in the batch processing registering portion 630 according to the arrangement order of the icons. The batch processing support program 100 then stores the settings information of the new batch processing in a predetermined batch processing settings information folder 121-n.

An icon for the batch processing settings information folder 121-n in which the settings information of the new batch processing is stored is assigned with the batch processing name entered in the batch processing name entry box 620 of the batch processing settings registering screen 600, and the icon is added to and displayed in the batch processing settings folder 120 (step S308).

When executing batch processing, a file is dragged from a file list display portion 450 displaying a list of files and dropped on an icon for a folder having stored settings information of the desired batch processing in the batch processing settings folder 120 displayed on the batch processing support screen 400, or the icon is double-clicked with the mouse, or “Execute” is selected from the pop-up menu displayed by a right click. Thereby, the batch processing support program 100 causes the GUI 104 and the batch processing execution unit 103 to sequentially execute plural individual processing tasks or batch processing tasks registered for the batch processing in a series of order on the basis of the settings information of the batch processing (step S309).

More specifically, the batch processing support program 100 analyzes the settings information of the batch processing instructed to execute, accesses the individual processing tasks or batch processing tasks registered for the batch processing based on the analysis result, and executes the individual processing tasks or the batch processing tasks in a series of order based on the settings of each of the processing tasks.

FIG. 4 is a diagram illustrating an example of the batch processing support screen 400 described above.

As shown in FIG. 4, the batch processing support screen 400 includes a title bar 410, a menu bar 420, a tool bar 430, a folder list display portion 440 for displaying a list of folders, a file list display portion 450 for displaying a list of folders or files stored in each of the folders displayed in the folder list display portion 440, and a function key display portion 460 for displaying a function of a function key.

In the folder list display portion 440, there is displayed a batch processing support folder 470 storing therein folders in which various data and processing program files required for operation of the batch processing support program 100 are stored, and the folders stored in the batch processing support folder 470 are also displayed in a hierarchical structure.

Specifically, below the batch processing support folder 470, there are displayed, for example, a storage folder 471, an image edition folder 112, a scan processing folder 111, a batch processing settings folder 120, and a print folder 113. The storage folder 471 stores individual folders 472, 473 and 474 for storing various data and files and assigned with folders names of Smith, Wilson, and Brown, respectively, and these individual folders 472 to 474 are displayed below the storage folder 471. The image edition folder 112 stores settings information of individual processing tasks for performing various processing tasks in the image processing, for example, a noise removal folder 110-1 storing settings information for performing a noise removal processing task for removing noise from the image data, an image rotation folder 110-2 storing settings information for a rotation processing task for rotating the image, and a tilt correction folder 110-3 storing settings information for a tilt correction processing task for correcting tilt in the image. The scan processing folder 111 stores an image scan folder 110-4 storing settings information for an image scan processing task for scanning image data from an original document by means of the image scanner 3. The batch processing settings folder 120 stores a batch processing A folder 121-1, a batch processing B folder 121-2 and so on which store settings information of batch processing for sequentially executing one or more individual processing tasks in a series of procedures (hereafter, to be generally referred to as “batch processing settings information folder 121-n”). The print folder 113 stores a DocuWide500 folder 110-7 storing settings information of a print processing task for printing out the image data by means of the printer 2.

Here, those folders storing settings information for the individual processing tasks and stored in the in the batch processing support folder 470 (e.g., the noise removal folder 110-1, the rotation folder 110-2, and the tilt correction folder 110-3) are to be generally referred to as the “settings information folder 110-n”. If the settings information folder 110-n for the individual processing task to be executed in batch processing is not registered in the batch processing support folder 470, the batch processing support folder 470 or the settings information folder 110-n storing settings information for the individual processing task to be newly registered is clicked with the right mouse button. When “Register Settings of Individual processing” is selected from a pop-up menu (not shown) thereby displayed, another pop-up menu (not shown) is displayed to show a list of individual processing tasks. When the user selects the desired individual processing task from the list, a individual processing settings registering screen 500 as shown in FIG. 5 is displayed on the batch processing support screen 400. When the user enters data in the specified entry boxes or selects an item from the options in the individual processing settings registering screen 500, the settings information for the individual processing task is registered and stored in the settings information folder 110-n thus designated or in the batch processing support folder 470.

FIG. 5 is a diagram illustrating an example of the individual processing settings registering screen 500. The individual processing settings registering screen 500 shown in FIG. 5 displays, for an example, the settings information for the tilt correction processing to automatically correct the tilt in the image data to the right direction during image processing.

When the user clicks, with the right mouse button, a folder (e.g., the image edition folder 112) in which the settings information for the tilt correction processing to automatically correct the tilt in the image to a right direction is to be registered, a pop-up menu (not shown) is displayed. When “Register Settings of Individual processing” is selected from the pop-up menu, another pop-up menu (not shown) is displayed to show a list of individual processing tasks. When “Tilt Correction Processing” is selected with the mouse, the tilt correction property screen 500 (individual processing settings registering screen) is displayed to allow the user to perform settings of the tilt correction processing.

As shown in FIG. 5, the tilt correction property screen 500 includes a title bar 510, a individual processing name entry portion 520, correction method setting portion 530, a correction direction selecting portion 540 (the portion enclosed with the broken line), a correction angle setting portion 550, and an operating button portion 560 (the portion enclosed with the broken line). In the title bar 510, there is displayed the title “Tilt Correction Property” is displayed as the title of the of the tilt correction property screen 500 (individual processing settings registering screen) corresponding to the “Tilt Correction Processing” selected from the list of individual processing tasks.

The correction method setting portion 530 in the tilt correction property screen 500 is used by the user to select whether the tilt correction processing is performed manually or automatically. The correction direction selecting portion 540 is then used to select whether the tilt correction is to be performed in the right or left direction, and then the correction angle setting portion 550 is used to determine how many degrees of tilt correction is to be performed. The name of the settings information folder 110-n for the tilt correction processing individual processing is the entered in the name entry portion 520. When the user selects the “OK” button in the operating button portion 560, the settings information folder 110-n, which stores settings information for the tilt correction processing to automatically correct the tilt in the image to the right direction, is created and stored in the tilt image edition folder 112.

In the example shown in FIG. 5, a folder assigned with the folder name “Tilt Correction: Automatic” as entered by the user in the individual processing name entry portion 20 is newly created, and settings information for the tilt correction processing to automatically rotate the image data to the right direction by 10 degrees is generated and stored in the settings information folder 110-n assigned with the name of “Tilt Correction: Automatic”. An icon associated with the settings information folder 110-n of “Tilt Correction: Automatic” is displayed.

When the contents of settings information for individual processing tasks already registered are to be edited by amending the same, for example, the icon for the settings information folder 110-n storing the settings information to be edited is clicked with the right mouse button, and “Edit Settings of Individual processing” is selected from a pop-up menu (not shown) thereby displayed. Thereby, a screen similar to the individual processing settings registering screen 500 shown in FIG. 5 corresponding to the individual processing task is displayed with default values being displayed in the respective entry boxes. The user is thus allowed to change the values in the entry boxes or in the option boxes as required on the screen. When the user then selects the “OK” button in the operating button portion, the settings information is updated to the setting contents thus changed.

When a settings information folder 110-n storing settings information for a individual processing task already registered is to be deleted, the icon for the settings information folder 110-n is clicked with the right mouse button, and “Delete Settings of Individual processing” is selected from a pop-up menu (not shown) displayed. Thereby, the settings information for the individual processing and the settings information folder 110-n storing the settings information are deleted.

For creating a batch processing task, the batch processing settings folder 120 displayed in the folder list display portion 440 of the batch processing support screen 400 is clicked with the right mouse button, and “Create New Batch Processing” is selected from a pop-up menu (not shown) displayed. Thereby, a new batch processing task for sequentially executing the existing individual processing tasks or batch processing tasks in a series of procedures can be created and stored.

More specifically, when the batch processing settings folder 120 is clicked with the right mouse button, and “Create New Batch Processing” is selected from the pop-up menu (not shown) displayed, a batch processing settings registering screen 600 as shown in FIG. 6 is displayed on the batch processing support screen 400.

As shown in FIG. 6, the batch processing settings registering screen 600 includes a title bar 610, a batch processing name entry box 620 for entering a name of a folder to store settings information for a batch processing task to be newly created, a batch processing registering portion 630 for registering individual processing tasks to be executed in the batch processing, a batch processing information display portion 640 for displaying the sequence of implementation and the contents of the plural individual processing tasks registered in the batch processing based on the settings information for those individual processing tasks, an edition operating button portion 650 for giving instructions to add a individual processing task to the batch processing task, to edit, and to delete a individual processing task from the batch processing task, a registration operating button portion 660 for giving instructions to store the settings information for the batch processing or to cancel the setting contents, and an icon change button 670 for changing icons associated with the settings information folders 110-n for the individual processing tasks registered in the batch processing registering portion 630.

A description will be made of an example in which a batch processing task C is created for sequentially executing individual processing tasks in the order of an image scan processing task to read image data is read from an original document with the image scanner 3, a noise removal processing task to subject the read image data to relatively substantial level of noise removal, and a print processing task to print out the image data thus processed by means of the printer 2. The icon of the settings information folder 110-4 of the image scan processing task stored in the scan processing folder 111 displayed in the folder list display portion 440 of the batch processing support screen 400 is dragged and dropped on the batch processing registering portion 630 of the batch processing settings registering screen 600, whereby the icon is copied to and displayed in the batch processing registering portion 630, while the name of the individual processing settings information folder 110-n associated with the icon is displayed below the icon.

Similarly, the icons of the settings information folder 110-1 for the noise removal processing in the image edition folder 112 and of the settings information folder 110-7 for the print processing in the print folder 113 displayed in the folder list display portion 440 of the batch processing support screen 400 are dragged and dropped on the batch processing registering portion 630 of the batch processing settings registering screen 600. Alternatively, the “Addition (A)” button in the registration operating button portion in the batch processing settings registering screen 600 is clicked with the mouse. A processing list screen (not shown) is thereby displayed to allow the user to select the individual processing task to be registered. Thereby, the icons of the settings information folder 110-1 of the noise removal processing and of the settings information folder 110-7 of the print processing are copied to the batch processing registering portion 630, and the processing contents of the individual processing tasks associated with the copied icons are displayed.

Confirming that the icons of the settings information folders 110-4, 110-1, and 110-7 for the image scan processing, noise removal processing, and print processing are copied and displayed in the batch processing registering portion 630, the user enters, in the batch processing name entry box 620, “Batch Processing C”, for example, and then clicks with the mouse the “OK” button in the registration operating button portion 660 of the batch processing settings registering screen 600. Thereby, settings information for a new batch processing task is created for sequentially executing the individual processing tasks in the order of the image data read processing by the image scanner 3 (image scan processing task), the substantial level of noise removal to the image data read by the mage scanner 3 (noise removal processing task), and the print-out of the processed image data by the printer 2 (print processing task). The settings information of the batch processing task C is stored in a batch processing settings information folder 121-n (not shown), which is in turn stored in the batch processing settings folder 120. An icon associated with the batch processing settings information folder 121-n of the batch processing task C is displayed.

In order to change the setting contents of a batch processing task already created and stored, the icon of the batch processing settings information folder 121-n of the corresponding batch processing task displayed on the batch processing support screen 400 is clicked with the right mouse button. “Edit Settings of Batch Processing” is selected from a pop-up menu (not shown) thereby displayed. Thereby, a batch processing settings editing screen corresponding to the batch processing task and similar to the batch processing settings registering screen 600 shown in FIG. 6 is displayed. In the batch processing settings editing screen thus displayed, default values are shown in the batch processing name entry portion, the batch processing registering portion and the batch processing information display portion, while the icons of the settings information folders 110-n of the individual processing tasks already registered are also shown as defaults. The user is thus allowed to change the setting contents of the batch processing in this screen.

More specifically, in order to add a individual processing task to a batch processing task already created, the icon of the settings information folder 110-n of the individual processing task to be added displayed in the folder list display portion 440 of the batch processing support screen 400 is dragged and dropped on the batch processing registering portion of the batch processing settings editing screen. Thereby, the dropped icon of the settings information folder 110-n of the individual processing task is additionally registered in the batch processing registering portion. When the individual processing task is additionally registered in this manner, the order of executing the individual processing tasks is automatically determined based on the settings information and processing contents of the individual processing tasks previously registered for the batch processing and of those individual processing tasks additionally registered. The icons of the individual processing settings information folders 110-n are rearranged and displayed in the order thus determined.

In order to change the order of executing individual processing tasks already registered in an existing batch processing task, the icons of the settings information folders 110-n of the individual processing tasks registered in the batch processing registering portion in the batch processing settings editing screen are dragged and dropped so as to change the arrangement of the icons within the batch processing registering portion according to the desired order of executing the individual processing tasks. Thereby, the settings of the batch processing task are changed such that the individual processing tasks are sequentially executed in the order in which the icons associated with the individual processing tasks are arranged. When the “OK” button in the registration operating button portion 660 is clicked with the mouse, the settings information of the corresponding batch processing task is updated accordingly.

In order to change the settings of a individual processing task already registered in an existing batch processing task, the icon of the settings information folder 110-n of the individual processing task the settings of which are to be changed is selected with the mouse from among the icons of the settings information folders 110-n of the individual processing tasks already registered in the batch processing registering portion of the batch processing settings editing screen. The “Edit (F)” button in the registration operating button portion in the batch processing settings editing screen is then clicked with the mouse, whereby the settings registering screen 500 for the selected icon is displayed to allow the user to change the settings in the screen. When the “OK” button in the registration operating button portion 660 is clicked with the mouse, the settings information of the corresponding batch processing is updated accordingly.

In order to delete a individual processing task already registered in an existing batch processing task, the icon of the settings information folder 110-n of the individual processing task to be deleted is selected with the mouse from among the icons of the settings information folders 110-n of the individual processing tasks already registered in the batch processing registering portion in the batch processing settings editing screen. The “Delete (D)” button in the registration operating button portion in the batch processing settings editing screen is then clicked with the mouse, whereby the selected icon is deleted from the batch processing registering portion. When the “OK” button in the registration operating button portion 660 is clicked with the mouse, the settings information of the corresponding batch processing task is updated to the one in which the individual processing task associated with the deleted icon has been deleted.

As described above, the batch processing support apparatus and method, and program according to the present invention makes it possible to easily register any processing task as a new task to be executed in batch processing regardless of types of settings of individual processing tasks and batch processing tasks already registered.

It is also possible to change the order or executing individual processing tasks or batch processing tasks registered for batch processing.

Further, according to the invention, a list of the names of respective individual processing tasks and of individual processing tasks registered for batch processing is displayed. This allows the user to view setting contents of plural individual processing tasks registered for batch processing at once.

As described above, according to an aspect of the present invention, a batch processing support apparatus for supporting batch processing in which a batch of individual processing tasks are sequentially executed, comprises a list display that displays a list of a plurality of individual processing tasks and batch processing tasks in which the plurality individual processing tasks are sequentially combined; a selection unit that selects and displays a plurality of desired processing tasks from the individual processing tasks and batch processing tasks displayed by the list display; a rearrangement unit that rearranges the plurality of processing tasks selected by the selection unit; a registering unit that registers a new batch processing task which sequentially executes the processing tasks in an order rearranged by the rearrangement unit; and a batch processing executing unit that executes the batch processing task registered by the registering unit.

According to another aspect of the present invention, the list display displays, in a list display area thereof, icons representing respectively the plurality of individual processing tasks and batch processing tasks having the plurality of individual processing tasks sequentially combined, and the selection unit selects the desired processing tasks by sequentially dragging the icons corresponding to the desired processing tasks displayed in the list display area, and sequentially dropping the icons in a predetermined selected processing display area, with the use of a mouse.

According to still another aspect of the present invention, in the batch processing support apparatus according to the another aspect of the invention, the rearrangement unit rearranges the plurality of processing tasks by dragging desired icons from among the icons dropped in the selected processing display area to desired positions, with the use of a mouse.

According to yet another aspect of the present invention, the new batch processing task registered by the registering unit is added to the batch processing tasks displayed by the list display; and the selection unit treats the added batch processing task as one of the options.

According to even another aspect of the present invention, when the selected processing task is a batch processing task, the selection unit displays the batch processing task by taking the batch processing task apart into individual processing tasks constituting the batch processing task.

According to further aspect of the present invention, a batch processing support method for supporting batch processing in which a batch of individual processing tasks are sequentially executed, comprises displaying, by a list display, a list of a plurality of individual processing tasks and batch processing tasks in which the plurality of individual processing are sequentially combined; selecting, by a selection unit, a plurality of desired processing tasks from the individual processing tasks and batch processing tasks displayed by the list display; rearranging, by a rearrangement unit, the plurality of processing tasks selected by the selection unit; registering, by a registering unit, a new batch processing task which sequentially executes the processing tasks in the order rearranged by the rearrangement unit; and executing, by a batch processing executing unit, the batch processing task registered by the registering unit.

According to still further aspect of the present invention, a storage medium readable by a computer stores a program of instructions executable by the computer to perform a function for causing the computer to perform batch processing support processing that supports a batch processing of sequentially executing individual processing tasks, the function comprising displaying a list of a plurality of individual processing tasks and batch processing tasks in which the plurality of individual processing tasks are sequentially combined; selecting a plurality of desired processing tasks from the individual processing tasks and batch processing tasks displayed in the list; rearranging the selected plurality of processing tasks; registering a new batch processing task which sequentially executes the processing tasks in an order rearranged; and executing the registered new batch processing task.

The forgoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-193757 filed on Jul. 1, 2005 including specification, claims, drawings and abstract is incorporated herein by reference in its entirety.

What is claimed is:

1. A batch processing support apparatus for supporting batch processing in which a batch of individual processing tasks are sequentially executed, the batch processing support apparatus comprising:
a list display that displays a list of a plurality of individual processing tasks and batch processing tasks in which the plurality individual processing tasks are sequentially combined;
a selection unit that selects and displays a plurality of desired processing tasks from the individual processing tasks and batch processing tasks displayed by the list display;
a rearrangement unit that rearranges the plurality of processing tasks selected by the selection unit;
a registering unit that registers a new batch processing task which sequentially executes the processing tasks in an order rearranged by the rearrangement unit; and
a batch processing executing unit that executes the batch processing task registered by the registering unit.

2. The batch processing support apparatus according to claim 1, wherein
the list display displays, in a list display area thereof, icons representing respectively the plurality of individual processing tasks and batch processing tasks having the plurality of individual processing tasks sequentially combined, and
the selection unit selects the desired processing tasks by sequentially dragging the icons corresponding to the desired processing tasks displayed in the list display area, and sequentially dropping the icons in a predetermined selected processing display area, with the use of a mouse.

3. The batch processing support apparatus according to claim 2, wherein the rearrangement unit rearranges the plurality of processing tasks by dragging desired icons from among the icons dropped in the selected processing display area to desired positions, with the use of a mouse.

4. The batch processing support apparatus according to claim 1, wherein
the new batch processing task registered by the registering unit is added to the batch processing tasks displayed by the list display; and
the selection unit treats the added batch processing task as one of the options.

5. The batch processing support apparatus according to claim 1, wherein when the selected processing task is a batch processing task, the selection unit displays the batch processing task by taking the batch processing task apart into individual processing tasks constituting the batch processing task.

6. A batch processing support method for supporting batch processing in which a batch of individual processing tasks are sequentially executed, the method comprising:
displaying, by a list display, a list of a plurality of individual processing tasks and batch processing tasks in which the plurality of individual processing are sequentially combined;
selecting, by a selection unit, a plurality of desired processing tasks from the individual processing tasks and batch processing tasks displayed by the list display;
rearranging, by a rearrangement unit, the plurality of processing tasks selected by the selection unit;
registering, by a registering unit, a new batch processing task which sequentially executes the processing tasks in the order rearranged by the rearrangement unit; and
executing, by a batch processing executing unit, the batch processing task registered by the registering unit.

7. A storage medium readable by a computer, the storage medium storing a program of instructions executable by the computer to perform a function for causing the computer to perform batch processing support processing that supports a batch processing of sequentially executing individual processing tasks, the function comprising:
displaying a list of a plurality of individual processing tasks and batch processing tasks in which the plurality of individual processing tasks are sequentially combined;
selecting a plurality of desired processing tasks from the individual processing tasks and batch processing tasks displayed in the list;
rearranging the selected plurality of processing tasks;
registering a new batch processing task which sequentially executes the processing tasks in an order rearranged; and
executing the registered new batch processing task.
